(19) United States
(12) Patent Application Publication
(10) Pub. No.: US 2009/0264072 A1
(43) Pub. Date: Oct. 22, 2009

(54) COMMUNICATION DEVICE AND VOLUME ADJUSTING METHOD FOR AUDIO DEVICE

(75) Inventor: LUNG DAI, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/239,833

(22) Filed: Sep. 29, 2008

(30) Foreign Application Priority Data
Apr. 18, 2008 (CN) 200810301197.7

(51) Int. Cl. H04B 7/00

(52) U.S. Cl. 455/41.2; 455/70

(57) ABSTRACT

An exemplary communication device is capable of adjusting a sound volume on an audio device. The communication device includes an input module, a communication unit, a signal generator, and a wireless transmitter. The input module is configured for receiving a first input. The communication unit is configured for receiving a call, and answering the call in response to the first input. The signal generator is configured for generating a first control signal when the communication unit answers the call. The wireless transmitter is configured for sending the first control signal to the audio device to change a current sound volume on the audio device from a first volume value to a first predetermined value. A related volume adjusting method for an audio device is also provided.

### BACKGROUND

1. Field of the Invention

The present invention relates to communication devices, and more particularly to a wireless communication device which is capable of adjusting a sound volume on an audio device.

2. Description of Related Art

Communication devices, such as mobile telephones, and audio devices, such as televisions (TVs), sound systems, computers, etc. are ubiquitous, and make our lives convenient, rich and colorful. However, when listening to an audio device and receiving an incoming call from a communication device such as a mobile phone, the sound output of the audio device may affect the conversation of the user of the mobile phone. The user may have to move away from the audio device or decrease a sound volume on the audio device manually, such that the conversation is clearer and less affected by the audible sound outputted by the audio device 10. As a consequent this poses an inconvenience to the user.

Therefore, an improved communication device and volume adjusting method for an audio device are needed to address the aforementioned deficiency and inadequacies.

### SUMMARY

An exemplary communication device is capable of adjusting a sound volume on an audio device. The communication device includes an input module, a communication unit, a signal generator, and a wireless transmitter. The input module is configured for receiving a first input. The communication unit is configured for receiving a call, and answering the call in response to the first input. The signal generator is configured for generating a first control signal when the communication unit answers the call. The wireless transmitter is configured for sending the first control signal to the audio device to change a current sound volume on the audio device from a first volume value to a first predetermined value.

Other advantages and novel features of the present invention will become more apparent from the following detailed description of an embodiment/embodiments when taken in conjunction with the accompanying drawings.

### BRIEF DESCRIPTION OF THE DRAWINGS

FIG. 1 is a block diagram of a communication device and an audio device in accordance with a first exemplary embodiment.

FIG. 2 is a block diagram of a communication device and an audio device in accordance with a second exemplary embodiment.

FIG. 3 is a flowchart of a volume adjusting method for an audio device in accordance with an exemplary embodiment.

### DETAILED DESCRIPTION

References will now be made to the drawings to describe preferred embodiments of the present communication device and volume adjusting method for an audio device.

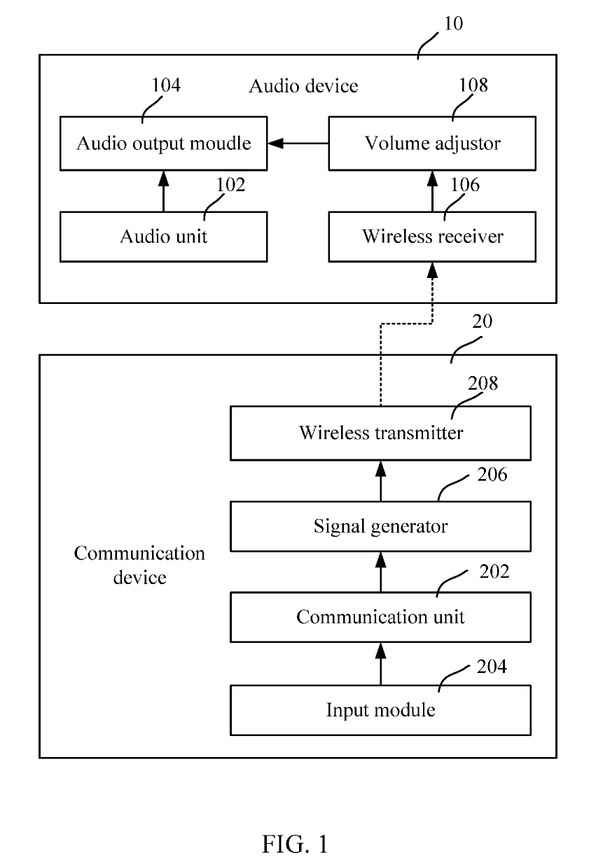

Referring to FIG. 1, an audio device 10 and a communication device 20 in accordance with a first exemplary embodiment are illustrated. The communication device 20 is capable of adjusting a sound volume on the audio device 10. The communication device 20 may be a mobile phone, a cordless telephone, or a computer having a telephone function. The audio device 10 may be a television (TV), a sound system, or a computer.

The audio device 10 includes an audio unit 102, an audio output module 104, a wireless receiver 106, and a volume adjustor 108.

The audio unit 102 is configured for outputting audio signals. The audio output module 104 is configured for outputting audible sound corresponding to the audio signals. The volume adjustor 108 is configured for adjusting a sound volume value of the audible sound outputted by the audio output module 104. The wireless receiver 106 is configured for communicating with the communication device 20. The volume adjustor 108 is configured to be controllable by the communication device 20.

The communication device 20 includes a communication unit 202, an input module 204, a signal generator 206, and a wireless transmitter 208.

The input module 204 is configured for receiving user's inputs. The input module 204 may be a keyboard having a plurality of input keys, or a touch-screen. In the exemplary embodiment, the user's inputs include a first input for answering a call, and a second input for ending/hanging up the call (terminating the already answered call).

The communication unit 202 is configured for communicating with other communication terminals. In detail, the communication unit 202 receives phone calls, makes phone calls, generates corresponding alert signals when receiving the calls, establishes a communication connection for each of the calls (that is, answers the call) when receiving the first input, and cuts off the communication connection (that is, ends/hanging up the call) when receiving the second input. The alert signals may be audible sound alerts, or vibration alerts, or visual alerts, or any combinations of the aforementioned alert types.

The signal generator 206 is configured for generating a first control signal when the communication unit 202 answers a call, and generating a second control signal when the communication unit 202 hangs up the call. In an exemplary embodiment, the communication unit 202 may signal the signal generator 206 when the communication unit 202 establishes the communication connection for the call and cuts off the communication connection, and then the signal generator 206 generates the first control signal and the second control signal correspondingly. In an alternative exemplary embodiment, the signal generator 206 detects an operation state change of the communication unit 202. When the signal generator 206 determines that the communication unit 202 establishes the communication connection for the call, that is, the operation state of the communication unit 202 changes from a stand-by state to a conversation state, the first control signal is generated and sent to the wireless transmitter 208. When the signal generator 206 determines that the communication unit 202 cuts off/disconnects the communication connection, that is, the operation state of the communication unit 202 changes from the conversation state to the stand-by state, the second control signal is generated and sent to the wireless transmitter 208.

The wireless transmitter 208 is configured for communicating with the audio device 10. In detail, the wireless transmitter 208 sends the first control signal and the second control signal to the audio device 10. The first control signal is used for signaling the audio device 10 to change the current sound volume (having a first volume value, such as a user preferred volume setting) to a first predetermined value. Understandably, the first predetermined value is low enough that will not affect a conversation of the user when conversing on the communication device, and the first predetermined value is usually lower than the first volume value. The second control signal is used for signaling the audio device 10 to change the current sound volume from the first predetermined value to a second predetermined value. The first control signal and the second control signal may be sent in the form of infrared rays or other wireless signals, such as radio or BLUETOOTH signals.

In the exemplary embodiment, the second predetermined value equals to the first volume value (previous volume). That is, when receiving the second control signal via the wireless receiver 106, the volume adjustor 108 changes the current sound volume from the first predetermined value to the first volume value. In the exemplary embodiment, the audio device 10 stores the first volume value in a storage unit (not shown) when receiving the first control signal, and when receiving the second control signal the audio device 10 changes the current sound volume from the first predetermined value to the first volume value according to the first volume value stored in the storage unit.

As described above, when the communication device 20 receives an incoming call and the call is answered, the sound volume of the audio device 10 is changed to the first predetermined value automatically. Therefore, the user of the communication device 20 will be able to have a clearer conversation with the caller because it would be less affected by the audible sound outputted by the audio device 10. When the conversation has ended, the sound volume on the audio device 10 is automatically returned to the previous volume value, thus, making it convenient for a user to listen to the audio device 10 at his preferred volume.

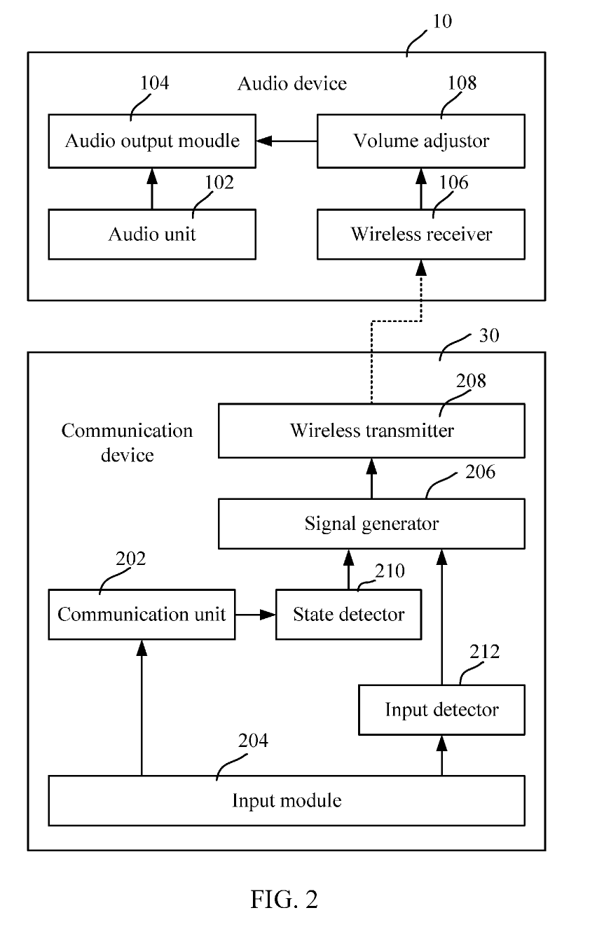

Referring to FIG. 2, the audio device 10 and a communication device 30 in accordance with a second exemplary embodiment are illustrated. Compared with the communication device 20, the communication device 30 further includes a state detector 210 connected between the communication unit 202 and the signal generator 206, and an input detector 212 connected between the input module 204 and the signal generator 206.

The state detector 210 is configured for detecting an operation state of the communication unit 202, generating a first state signal when the communication unit 202 receives a call (incoming call alert state). The input detector 212 is configured for generating a second state signal when the input module 204 receives the first input for answering the call, and generating a third state signal when the input module 204 receives the second input for ending/hanging up the call.

In the exemplary embodiment, the signal generator 206 generates the first control signal when receiving the first and second state signals, and generates the second control signal when receiving the third state signal.

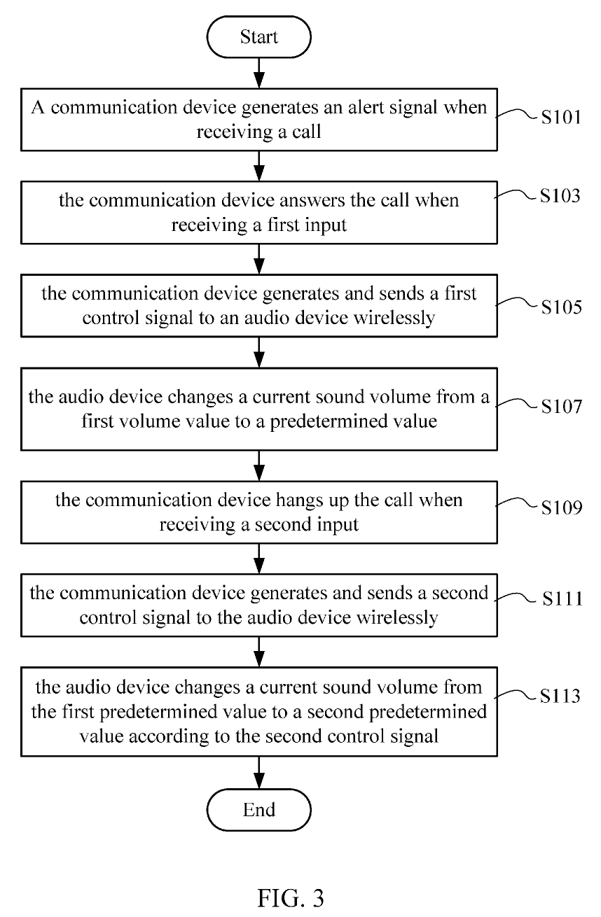

Referring to FIG. 3, a volume adjusting method implemented by the communication device 20 of FIG. 1 in accordance with an exemplary embodiment is illustrated. The volume adjusting method is used for adjusting a sound volume on an audio device, such as the audio device 10, when the communication device 20 answers a call. The volume adjusting method includes the following blocks:

In block S101, the communication device 20 generates an alert signal when receiving an incoming call. The alert signal may be an audible sound alert, or a vibration alert, or a visual alert, or any combination of the aforementioned alert types.

In block S103, the communication device 20 answers the call when receiving a first input, that is, establishes a communication connection between the communication device 20 and the caller.

In block S105, the communication device 20 generates a first control signal, and sends the first control signal to the audio device 10 wirelessly. The first control signal may be sent in the form of infrared rays or other wireless signals such as BLUETOOTH signals.

In block S107, the audio device 10 stores a first volume value of a current sound volume of the audible sound outputted from the audio device 10, and change the current sound volume from the first volume value to a first predetermined value according to the first control signal.

In block S109, the communication device 20 ends/hangs up the call when receiving a second input, that is, cuts off the communication connection between the communication device 20 and the caller of the call.

In block S111, the communication device 20 generates a second control signal, and sends the second control signal to the audio device 10 wirelessly.

In block S113, the audio device 10 changes the current sound volume from the first determined value to a second predetermined value according to the second control signal. In the exemplary embodiment, the second predetermined value equals to the first volume value (previous volume).

In an alternative embodiment, the second predetermined value may be not equal to the first volume value.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A volume adjusting method for an audio device comprising:
a communication device generates an alert signal when receiving a call;
the communication device answers the call, generates a first control signal, and sends the first control signal to the audio device wirelessly in response to a first input; and
the audio device changes a current sound volume from a first volume value to a first predetermined value according to the first control signal.

2. The method as claimed in claim 1, wherein the first volume value of the current sound volume is higher than the first predetermined value.

3. The method as claimed in claim 1, further comprising:
the communication device ends the call, generates a second control signal, and sends the second control signal to the audio device wirelessly in response to a second input; and
the audio device changes a current sound volume from the first predetermined value to a second predetermined value according to the second control signal.

4. The method as claimed in claim 3, wherein the second predetermined value equals to the first volume value.

5. The method as claimed in claim 4, further comprising: the audio device stores the first volume value in response to the first control signal, and changes the current sound volume from the first predetermined value to the first volume value according to the stored first volume value.

6. The method as claimed in claim 1, wherein the first control signal is sent in the form of one of infrared rays, a radio signal, or a BLUETOOTH signal.

7. A volume adjusting method for an audio device, implemented by a communication device, comprising:
generating an alert signal when receiving a call;
answering the call, and generating a first control signal when receiving a first input; and
sending the first control signal to the audio device wirelessly to change a current sound volume on the audio device from a first volume value to a first predetermined value.

8. The method as claimed in claim 7, wherein the first volume value is higher than the first predetermined value.

9. The method as claimed in claim 7, further comprising:
hanging up the call when receiving a second input;
generating a second control signal; and
sending the second control signal to the audio device wirelessly to change a current sound volume from the first predetermined value to a second predetermined value.

10. The method as claimed in claim 9, wherein the second predetermined value equals to the first volume value.

11. The method as claimed in claim 7, wherein the first control signal is sent in the form of one of infrared rays, a radio signal, or a BLUETOOTH signal.

12. A communication device, capable of adjusting a sound volume on an audio device, comprising:
an input module for receiving a first input;
a communication unit for receiving a call, and answering the call in response to the first input;
a signal generator for generating a first control signal when the communication unit answers the call; and
a wireless transmitter for sending the first control signal to the audio device to change a current sound volume on the audio device from a first volume value to a first predetermined value.

13. The communication device as claimed in claim 12, further comprising:
a state detector for generating a first state signal when the communication unit receives a call; and
an input detector for generating a second state signal when the input module receives the first input;
wherein the signal generator generates the first control signal when receiving the first state signal and the second state signal.

14. The communication device as claimed in claim 13, wherein the input detector is further configured for generating a third state signal when the input module receives the second input for hanging up the call, and the signal generator is further configured for generating a second control signal when receiving the third state signal, the second control signal is used for changing a current sound volume on the audio device from the first predetermined value to a second predetermined value.

15. The communication device as claimed in claim 12, wherein the communication unit is further configured for generating an alert signal when receiving the call.

16. The communication device as claimed in claim 12, wherein the input module is further configured for receiving a second input, the signal generator is further configured for generating a second control signal when the communication unit hangs up the call according to the second input; and the wireless transmitter is further configured for sending the second control signal to the audio device to change a current sound volume on the audio device from the first predetermined value to a second predetermined value.

17. The communication device as claimed in claim 16, wherein the second predetermined value equals to the first volume value.

18. The communication device as claimed in claim 16, wherein the first and second control signals are sent in the form of one of infrared rays, radio signals, or BLUETOOTH signals.
